(19) United States
(12) Patent Application Publication
(10) Pub. No.: US 2017/0181193 A1
(43) Pub. Date: Jun. 22, 2017

(54) METHOD AND APPARATUS FOR RECEIVING UPLINK SIGNAL

(71) Applicant: ELECTRONICS AND TELECOMMUNICATIONS RESEARCH INSTITUTE, Daejeon (KR)

(72) Inventors: Hyeong Sook PARK, Daejeon (KR); IL GYU KIM, Chungcheongbuk-do (KR); Jun-Woo KIM, Daejeon (KR)

(73) Assignee: ELECTRONICS AND TELECOMMUNICATIONS RESEARCH INSTITUTE, Daejeon (KR)

(21) Appl. No.: 15/381,960

(22) Filed: Dec. 16, 2016

(30) Foreign Application Priority Data
Dec. 16, 2015 (KR) 10-2015-0180480
Dec. 15, 2016 (KR) 10-2016-0171981

(51) Int. Cl. H04W 74/08; H04W 16/28; H04B 17/318

(52) U.S. Cl. CPC H04W 74/0833; H04B 17/318; H04W 16/28

(57) ABSTRACT

Disclosed herein are an apparatus and a method for receiving uplink data to determine whether to use a reception beam group in reception of the uplink data on the basis of a preamble for a random access or a CQI included in a feedback.

### CROSS-REFERENCE TO RELATED APPLICATION

This application claims priority to and the benefit of Korean Patent Application Nos. 10-2015-0180480 and 10-2016-0171981 filed in the Korean Intellectual Property Office on Dec. 16, 2015, and Dec. 15, 2016, the entire contents of which are incorporated herein by reference.

### BACKGROUND OF THE INVENTION

(a) Field of the Invention

The present invention relates to an apparatus and a method for receiving uplink signal using a reception beam group.

(b) Description of the Related Art

In recent years, to meet a demand for continuously increasing traffic of a wireless communication system, researches for increasing a data transmission rate by extending a bandwidth such as a millimeter-wave band are in progress. To reduce a propagation path loss due to propagation characteristics of the millimeter-wave band and increase a transfer distance of a radio wave, a beamforming technology using an array antenna having a form in which a plurality of antennas are arrayed is essential. According to the beamforming technology, a base station transmitting a multiple beam and a terminal receiving a beam from the base station may concentrate transmission and reception of the radio wave in a specific direction to obtain a gain. As the beamforming technology, there are an adaptive beamforming scheme and a static beamforming scheme. At present, the static beamforming scheme is preferentially considered due to hardware complexity and operating overhead. The static beamforming technology overlaps the beam to prevent a coverage hole. In this case, there is a problem in that the overlapping multiple beam increases the inter-beam interference of the transmitted and received signal to cause a deterioration in system performance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for receiving uplink signal using a reception beam group.

An exemplary embodiment of the present invention provides an apparatus for receiving uplink signal, including: a processor, a memory, and a radio frequency unit, wherein the processor executes a program stored in the memory to perform steps of: receiving a preamble for a random access from a plurality of terminals; determining whether to use a reception beam group for receiving the uplink signal from a first terminal on the basis of received power of a first preamble of the first terminal transmitting the uplink signal among the plurality of terminals; and receiving the uplink signal by using the reception beam group or a single beam based on a result of the determining.

When determining whether to use a reception beam group for reception of the uplink signal from a first terminal, the processor may perform steps of: measuring a first received power of a random access (RA) code corresponding to an index of the first preamble among a plurality of RA codes within a reception beam on which the first preamble is carried; and comparing the first received power with a second received power of a the first RA code within other beams.

When receiving the uplink signal by using the reception beam group or a single beam based on a result of the determining, the processor may perform a step of: if a proportion between the first received power and the second received power is larger than a preset value, receiving the uplink signal by using the single beam, or if the proportion is not larger than the preset value, receiving the uplink signal by using the reception beam group.

The preset value may be a value which is indicated by a higher layer.

The reception beam group may include the maximum M1 of beams, in which the M1 may be a natural number larger than 2 determined in consideration of a receive maximal ratio combining gain of an array antenna.

Another exemplary embodiment of the present invention provides a method for receiving uplink data, including: receiving a preamble for a random access from a plurality of terminals; determining whether to use a reception beam group for receiving the uplink signal from a first terminal on the basis of received power of a first preamble of the first terminal transmitting the uplink signal among the plurality of terminals; and receiving the uplink signal by using the reception beam group or a single beam based on a result of the determining.

The determining may include: measuring a first received power of a random access (RA) code corresponding to an index of the first preamble among a plurality of RA codes within a reception beam on which the first preamble is carried; and comparing the first received power with a second received power of a the first RA code within other beams.

The receiving the uplink signal by using the reception beam group or a single beam based on a result of the determining may include if a proportion between the first received power and the second received power is larger than a preset value, receiving the uplink signal by using the single beam, or if the proportion is not larger than the preset value, receiving the uplink signal by using the reception beam group.

The preset value may be a value which is indicated by a higher layer.

The reception beam group may include the maximum M1 of beams, in which the M1 may be a natural number larger than 2 determined in consideration of a receive maximal ratio combining gain of an array antenna.

Yet another exemplary embodiment of the present invention provides an apparatus for receiving uplink signal, including: a processor, a memory, and a radio frequency unit, wherein the processor executes a program stored in the memory to perform steps of: determining whether to use a reception beam group for receiving the uplink signal from a first terminal among a plurality of terminals on the basis of result of comparison between a first channel quality indicator (CQI) of a serving beam and a second CQI of an interference beam among a plurality of CQIs measured from channels between a base station and the plurality of terminals; and receiving the uplink signal by using the reception beam group or a single beam based on a result of the determining.

Before determining whether to use the reception beam group for receiving the uplink signal, the processor may further perform a step of: receiving the plurality of CQIs from the first terminal.

A number of the plurality of CQIs may be M, in which the M may be smaller than a number of received beams by the first terminal and may be indicated by a higher layer.

Before determining whether to use the reception beam group for receiving the uplink signal, the processor may further perform steps of: receiving a sounding reference signal (SRS) from the first terminal; and measuring the plurality of CQIs by using the SRS.

When receiving the uplink signal by using the reception beam group or a single beam based on a result of the determining, the processor may perform a steps of: if a difference between the first CQI and the second CQI is larger than a preset value, receiving the uplink signal by using the single beam, or if the difference is not larger that the preset value, receiving the uplink signal by using the reception beam group.

The preset value may be a value which is indicated by a higher layer.

### BRIEF DESCRIPTION OF THE DRAWINGS

FIG. 1 is a diagram schematically illustrating a millimeter-wave-based mobile communication system according to an exemplary embodiment of the present invention.

FIG. 2 is a diagram schematically illustrating a downlink transmitting/receiving method between a base station and a terminal according to an exemplary embodiment of the present invention.

FIG. 3 is a flow chart schematically illustrating an uplink transmitting/receiving method between a base station and a terminal according to an exemplary embodiment of the present invention.

FIG. 4 is a flow chart illustrating a method for determining, by a base station, whether to use a reception beam group using a preamble of an RA procedure, according to an exemplary embodiment of the present invention.

FIG. 5 is a flow chart illustrating a method for determining, by a base station, whether to use a reception beam group using CQI according to an exemplary embodiment of the present invention.

FIG. 6 is a block diagram illustrating a wireless communication system according to an exemplary embodiment of the present invention.

### DETAILED DESCRIPTION OF THE EMBODIMENTS

Hereinafter, exemplary embodiments of the present invention will be described in detail with reference to the accompanying drawings so that those skilled in the art may easily practice the present invention. However, the present invention may be modified in various different ways and is not limited to embodiments described herein. In the accompanying drawings, portions unrelated to the description will be omitted in order to obviously describe the present invention, and similar reference numerals will be used to describe similar portions throughout the present specification.

Throughout the specification, a terminal may be called a mobile station (MS), a mobile terminal (MT), an advanced mobile station (AMS), a high reliability mobile station (HR-MS), a subscriber station (SS), a portable subscriber station (PSS), an access terminal (AT), a user equipment (UE), a machine type communication device (MTC device), and the like and may also include all or some of the functions of the MS, the MT, the AMS, the HR-MS, the SS, the PSS, the AT, the UE, the MTCH device, and the like.

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a macro base station (macro BS), a micro base station (micro BS), and the like), and the like and may also include all or some of the functions of the ABS, the node B, the eNodeB, the AP, the RAS, the BTS, the MMR-BS, the RS, the RN, the ARS, the HR-RS, the small base stations, and the like.

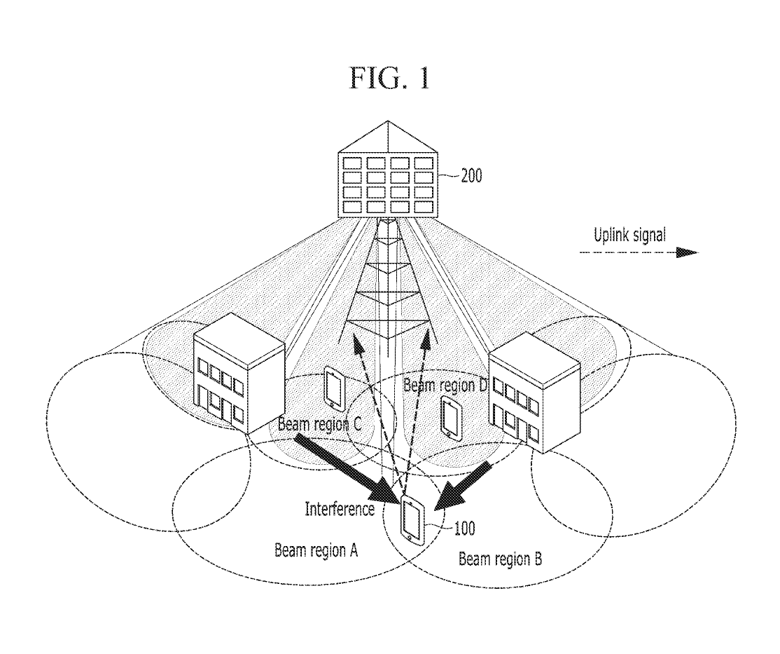

FIG. 1 is a diagram schematically illustrating a millimeter-wave-based mobile communication system according to an exemplary embodiment of the present invention.

In FIG. 1, a base station 200 transmits/receives a plurality of beams through an array antenna to provide a service to coverage. That is, the base station 200 uses a plurality (N) of beams to cover a fixed beam region. In this case, to prevent a coverage hole of a service region, beam regions overlap each other.

A terminal 100 performing static beamforming may use a beam received from the base station 200 to generate an uplink transmit beam. At this point, unlike the base station 200, the terminal 100 may transmit/receive a signal by switching P (N>>P) fixed beams due to restrictions (space, price, or the like) of implementation. Therefore, a form of the beam transmitted from the terminal 100 has a wider radiation form than a transmit beam of the base station 200. That is, the uplink signals are transmitted through a beam having a wider width than the downlink data and the terminal 100 is highly likely to be located in the overlapping region of the beams of the base station 200.

Meanwhile, in the mobile communication system, both of downlink and uplink share all beams for the control channel to which control information requiring high reliability is transmitted but a channel used for data transmission is independently configured by each beam. Further, the base station 200 receives a plurality of beams through an uplink channel, and therefore needs to combine the received multiple beam. At this point, if the base station 200 receives a data channel using all the beams like the control channel, the efficiency of the resource allocation may be reduced and if the base station receives the data channel using a single beam, the performance of the uplink data channel may be reduced.

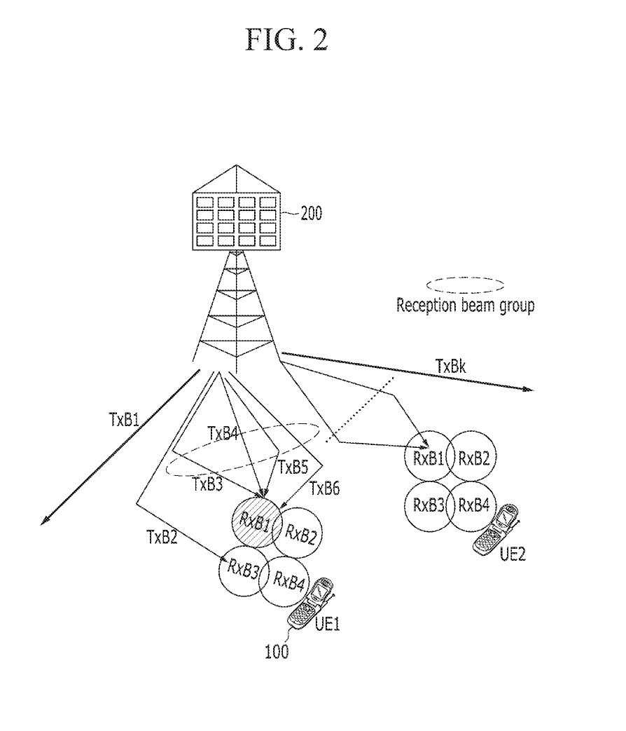

FIG. 2 is a diagram schematically illustrating a downlink transmitting/receiving method between a base station and a terminal according to an exemplary embodiment of the present invention.

Referring to FIG. 2, in the downlink of a time division duplex (TDD) system, the base station 200 transmits a plurality of beams TxB1 to TxBN and the terminal 100 receives a signal through four fixed beams RxB1 to RxB4. Generally, in the mobile communication system, the terminal 100 measures the quality of the downlink channel and periodically or aperiodically reports the measurement result of the downlink channel quality to the base station 200. According to the exemplary embodiment of the present invention, N beams used in the base station 200 each include a reference signal unique to the beam and the terminal 100 measures channels corresponding to each beam to feedback a channel quality indicator (CQI) to the base station 200. The CQI means that a signal to noise ratio (SNR) of the received signal is a value represented by bit depending on a preset level. For example, the SNR range of the received signal is between −3 [dB] and −29 [dB] and if the CQI is represented by 5 bits (i.e., 2⁵ levels), the SNR range corresponding to one CQI level is 1 [dB]. The terminal 100 may also feedback the CQIs for all the K beams and to reduce the overhead of the resource allocation, the CQIs for some M beams of all the N beams may also be fed back.

Referring to FIG. 2, the terminal 100 measures the CQI of the transmit beam corresponding to the reception beam RxB1 and the information on the transmit beam of which the CQI is measured as a large value is reported to the base station 200. In FIG. 2, the terminal 100 measures the CQIs for TxB3, TxB4, TxB5 and TxB6 among the transmit beams of the base station 200 and reports the measured CQIs to the base station 200. The terminal may feedback the CQIs for the preset number of beams to the base station. At this point, the number of CQIs fed back to the base station is the information included in the uplink control channel and may be defined by a standard.

Further, in the uplink, the terminal 100 transmits the uplink data channel using the same beam as the reception beam RxB1. Therefore, a beam width of the transmit beam is 90°. The base station 200 may receive a signal through the reception beam group.

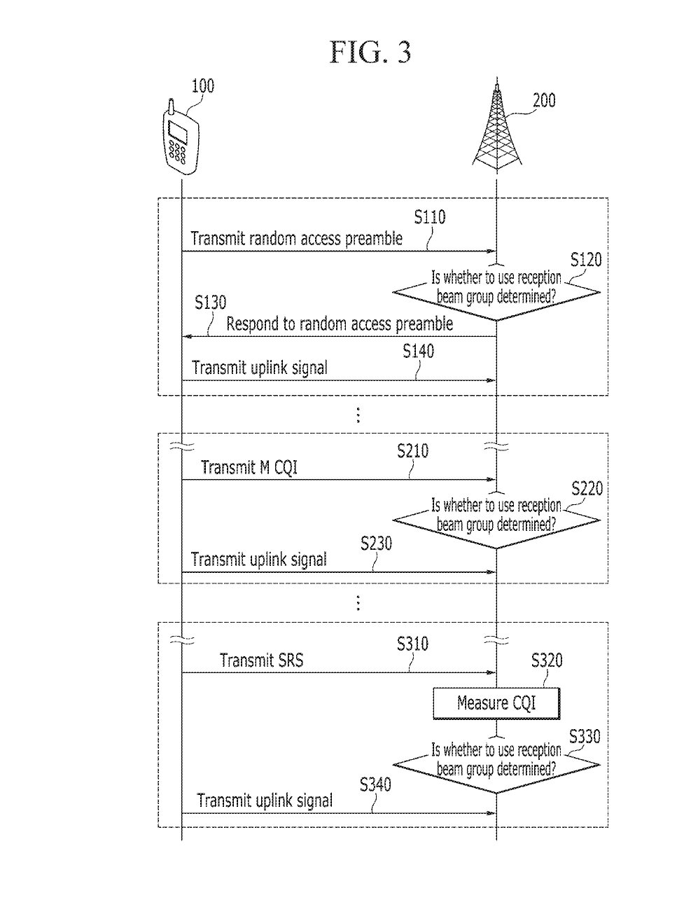

FIG. 3 is a flow chart schematically illustrating an uplink transmitting/receiving method between a base station and a terminal according to an exemplary embodiment of the present invention.

Referring to FIG. 3, the base station 200 may determine whether to use the reception beam group in the uplink in a random access (RA) process of the terminal 100, determine whether to use the reception beam group in the uplink using the CQI periodically fed back by the terminal 100, measure the CQI using a sounding reference signal (SRS) received from the terminal 100, and determine whether to use the reception beam group in the uplink using the measured CQI.

First, the base station 200 may use the preamble transmitted in the RA procedure of the terminal 100 to determine whether to use the reception beam group. The base station 200 may receive the preamble for the RA of the terminal 100 (S110) and transmit the RA response to the terminal 100 (S130). At this point, the base station 200 may determine whether to use the reception beam group in the uplink on the basis of power of the received preamble (S120) and may receive the uplink signal through the single beam or the reception beam group (S140).

Alternatively, the base station 200 of the time division duplexing (TDD) system may use the CQI periodically fed back by the terminal 100 to determine whether to use the reception beam group. When the terminal 100 requests the uplink resource and receives an uplink grant (UL grant) to transmit the uplink signal, the terminal 100 feeds back the CQIs for M beams to the base station 200 (S210). The base station 200 may determine whether to use the reception beam group on the basis of the CQIs for each beam received from the terminal 100 (S220) and receive the uplink signal through the single beam or the reception beam group (S230).

Alternatively, the base station 200 of the frequency division duplexing (FDD) system may determine whether to use the reception beam group in the uplink on the basis of the CQI measured using the SRS received from the terminal 100. The base station 200 receives the SRS of the terminal 100 (S310) and measures the CQI using the received SRS (S320). Next, the base station 200 may determine whether to use the reception beam group in the uplink on the basis of the measured CQI (S330) and receive the uplink data through the single beam or the reception beam group (S340).

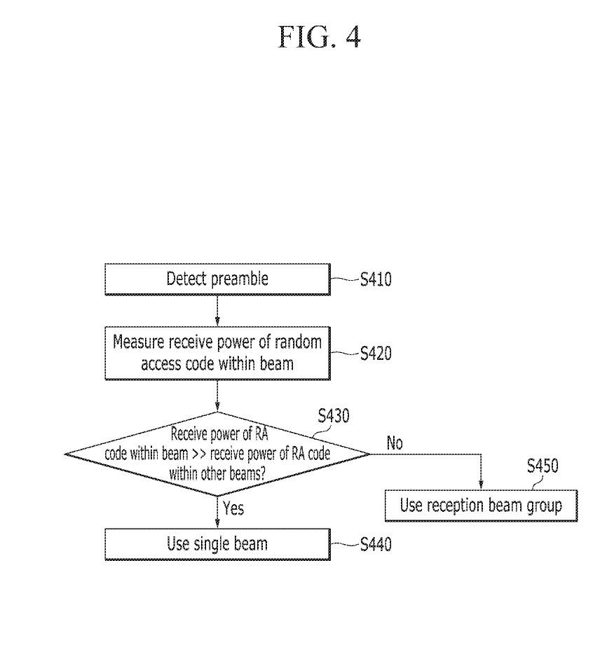

Hereinafter, a method for determining, by a base station 200, whether to use a reception beam group in uplink will be described in detail with reference to FIGS. 4 to 6.

FIG. 4 is a flow chart illustrating a method for determining, by a base station, whether to use a reception beam group using a preamble of an RA procedure according to an exemplary embodiment of the present invention.

Referring to FIG. 4, if a plurality of terminals 100 transmits the RA preamble, the base station 200 detects the preamble (S410). Next, the base station 200 measures the received power of the RA code corresponding to the index of the detected preamble among a plurality of RA codes within the reception beam on which the detected preamble is carried (S420). Further the base station 200 compares the measured received power of the RA code with the received power of the RA code corresponding to the index of the detected preamble among the plurality of RA codes within other beams (S430).

The base station 200 according to the exemplary embodiment of the present invention receives the uplink signal using the single beam when a difference between the received power of the RA code within the reception beam and the received power of the RA code within other beams is large (S440). However, when the difference between the received power of the RA code within the reception beam and the received power of the RA code within other beams is small, the base station 200 receives the uplink signal using the reception beam group (S450). In this case, the criteria of determining the size of the difference between the received powers may be preset, for example, a preset proportion between received powers may be indicated by a higher layer at an early stage of configuration by the base station. For example, if a proportion between the received power of the RA code within the reception beam and the received power of the RA code within other beams is not larger than the preset value, the base station may receive the uplink signal using the reception beam group and if a ratio between the received power of the RA code within the reception beam and the received power of the RA code within other beams is larger than the preset value, the base station may receive the uplink signal using the single beam.

Meanwhile, when the base station 200 uses the reception beam group to receive the uplink signal, the base station 200 may select one of a plurality of reception beam groups. The following Table 1 shows the reception beam group selected by the base station 200 and the beam index included in the reception beam group.

TABLE 1

| | |
|---|---|
| Reception beam group #0 | Beam #0, beam #1, . . . (up to M1 number) |
| . . . | . . . |
| Reception beam group #L-1 | Beam #0, beam #2, . . . , (up to M1 number) |

Referring to FIG. 1, each reception beam group includes up to M1 beams, and each reception beam group may include at least one different beam, in which the M1 may be indicated by the higher layer at the early stage of the configuration of the base station. Meanwhile, the base station 200 may determine the receiving antenna group in the antenna array to select the reception beam group. At this point, if the receiving antenna group includes at least 6 antennas, the maximum number of antennas included in the receiving antenna group may be limited to 6 by using the fact that an increment of a receive maximal ratio combining gain is relatively reduced. At this point, the maximum number M1 of the beam included in the reception beam group may be equal to the maximum number of antennas included in the receiving antenna group.

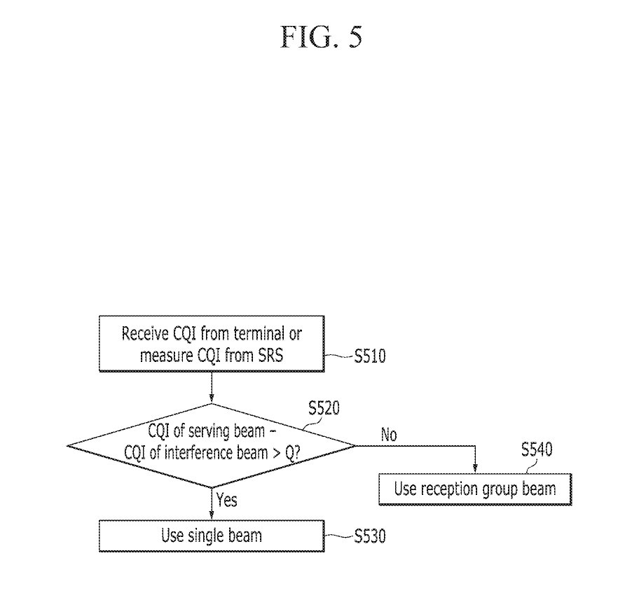

FIG. 5 is a flow chart illustrating a method for determining, by a base station 200, whether to use a reception beam group using CQI according to an exemplary embodiment of the present invention.

The base station 200 of the TDD system may receive the CQI periodically reported from the terminal 100 and determine whether to use the reception beam group using the received CQI. At this point, the number M of beams corresponding to the CQI fed back from the terminal 100 to the base station is preset according to the standard, in which the M is larger than the number M1 of beams included in the reception beam group (i.e., M M1). Alternatively, the base station 200 of the FDD system may measure the CQI using SRS received from the terminal 100 and determine whether to use the reception beam group using the measured CQI.

Referring to FIG. 5, the base station 200 of the TDD system receives the CQI from the terminal 100 and the base station 200 of the FDD system measures the CQI from the SRS transmitted by the terminal 100 (S510).

Next, the base station 200 compares the CQI corresponding to a serving beam with the CQI corresponding to an interference beam (S520). If the difference between the CQI of the serving beam and the CQI of the interference beam is larger than the preset value, the base station 200 receives the uplink signal through one reception beam (use the serving beam) (S530). However, if the difference between the CQI corresponding to the serving beam and the CQI corresponding to the interference beam is not larger than the preset value, the base station 200 receives the uplink signal through the reception beam group (use the reception beam group) (S540). The CQI of the serving beam and the CQI of the interference beam may be measured at a similar size when the terminal 100 is located at a beam boundary area of the base station 200. For example, if the difference between the CQI corresponding to the serving beam and the CQI corresponding to the interference beam is equal to or less than a preset Q (i.e., if the level difference of the CQI is smaller than Q level), the base station 200 may receive the uplink signal using the reception beam group. At this point, the preset Q value may be indicated by the higher layer at the early of the configuration of the base station.

According to an exemplary embodiment of the present invention, it is possible to improve the uplink signal receiving performance of the base station by receiving the uplink signal using the reception beam group including some of the plurality of beams for transmitting the uplink data.

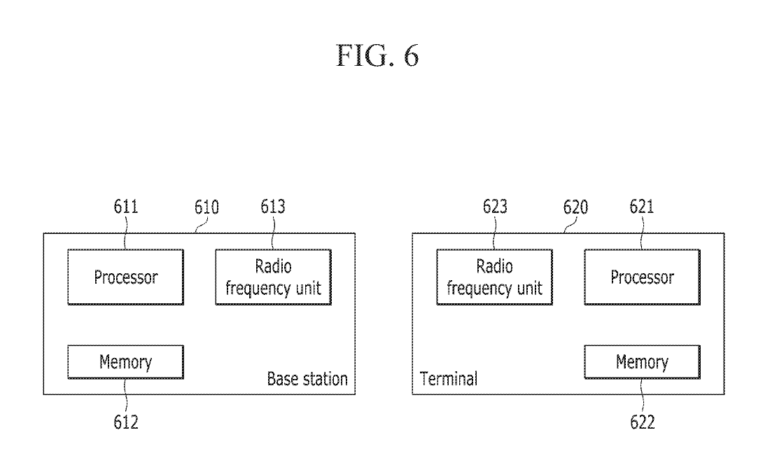

FIG. 6 is a block diagram illustrating a wireless communication system according to an exemplary embodiment of the present invention.

Referring to FIG. 6, a wireless communication system according to an exemplary embodiment of the present invention includes a base station 610 and a terminal 620.

The base station 610 includes a processor 611, a memory 612, and a radio frequency unit (RF unit) 613. The memory 612 may be connected to the processor 611 to store various pieces of information for driving the processor 611 or at least one program executed by the processor 611. The radio frequency unit 613 may be connected to the processor 611 to transmit/receive a wireless signal. The processor 611 may implement functions, processes, or methods proposed by the exemplary embodiment of the present disclosure. In this case, in the wireless communication system according to the exemplary embodiment of the present invention, a wireless interface protocol layer may be implemented by the processor 611. An operation of the base station 610 according to the exemplary embodiment of the present invention may be implemented by the processor 611.

The terminal 620 includes a processor 621, a memory 622, and a radio frequency unit 623. The memory 622 may be connected to the processor 621 to store various pieces of information for driving the processor 621 or at least one program executed by the processor 621. The radio frequency unit 623 may be connected to the processor 621 to transmit/receive a wireless signal. The processor 621 may implement functions, processes, or methods proposed by the exemplary embodiment of the present disclosure. In this case, in the wireless communication system according to the exemplary embodiment of the present invention, a wireless interface protocol layer may be implemented by the processor 621. An operation of the terminal 620 according to the exemplary embodiment of the present invention may be implemented by the processor 621.

According to the exemplary embodiment of the present invention, the memory may be positioned inside or outside the processor and the memory may be connected to the processor through already known various means. The memory is various types of volatile or non-volatile storage media. For example, the memory may include a read-only memory (ROM) or a random access memory (RAM).

Although the exemplary embodiment of the present invention has been described in detail hereinabove, the scope of the present invention is not limited thereto. That is, several modifications and alterations made by those skilled in the art using a basic concept of the present invention as defined in the claims fall within the scope of the present invention.

What is claimed is:

1. An apparatus for receiving uplink signal, comprising:
a processor, a memory, and a radio frequency unit,
wherein the processor executes a program stored in the memory to perform steps of:
receiving a preamble for a random access from a plurality of terminals;
determining whether to use a reception beam group for receiving the uplink signal from a first terminal on the basis of received power of a first preamble of the first terminal transmitting the uplink signal among the plurality of terminals; and
receiving the uplink signal by using the reception beam group or a single beam based on a result of the determining.

2. The apparatus of claim 1, wherein:
when determining whether to use a reception beam group for reception of the uplink signal from a first terminal, the processor performs steps of:
measuring a first received power of a random access (RA) code corresponding to an index of the first preamble among a plurality of RA codes within a reception beam on which the first preamble is carried; and
comparing the first received power with a second received power of a the first RA code within other beams.

3. The apparatus of claim 2, wherein:
when receiving the uplink signal by using the reception beam group or a single beam based on a result of the determining, the processor performs a step of
if a proportion between the first received power and the second received power is larger than a preset value, receiving the uplink signal by using the single beam, or if the proportion is not larger than the preset value, receiving the uplink signal by using the reception beam group.

4. The apparatus of claim 3, wherein the preset value is a value which is indicated by a higher layer.

5. The apparatus of claim 3, wherein the reception beam group includes the maximum M1 of beams, in which the M1 is natural number larger than 2 determined in consideration of a receive maximal ratio combining gain of an array antenna.

6. A method for receiving uplink data, comprising:
receiving a preamble for a random access from a plurality of terminals;
determining whether to use a reception beam group for receiving the uplink signal from a first terminal on the basis of received power of a first preamble of the first terminal transmitting the uplink signal among the plurality of terminals; and
receiving the uplink signal by using the reception beam group or a single beam based on a result of the determining.

7. The method of claim 6, wherein:
the determining includes:
measuring a first received power of a random access (RA) code corresponding to an index of the first preamble among a plurality of RA codes within a reception beam on which the first preamble is carried; and
comparing the first received power with a second received power of a the first RA code within other beams.

8. The method of claim 7, wherein:
the receiving the uplink signal by using the reception beam group or a single beam based on a result of the determining includes if a proportion between the first received power and the second received power is larger than a preset value, receiving the uplink signal by using the single beam, or if the proportion is not larger than the preset value, receiving the uplink signal by using the reception beam group.

9. The method of claim 8, wherein the preset value is a value which is indicated by a higher layer.

10. The method of claim 8, wherein
the reception beam group includes the maximum M1 of beams, in which the M1 is natural number larger than 2 determined in consideration of a receive maximal ratio combining gain of an array antenna.

11. An apparatus for receiving uplink signal, comprising:
a processor, a memory, and a radio frequency unit,
wherein the processor executes a program stored in the memory to perform steps of:
determining whether to use a reception beam group for receiving the uplink signal from a first terminal among a plurality of terminals on the basis of result of comparison between a first channel quality indicator (CQI) of a serving beam and a second CQI of an interference beam among a plurality of CQIs measured from channels between a base station and the plurality of terminals; and
receiving the uplink signal by using the reception beam group or a single beam based on a result of the determining.

12. The apparatus of claim 11, wherein:
before determining whether to use the reception beam group for receiving the uplink signal, the processor further performs a step of
receiving the plurality of CQIs from the first terminal.

13. The apparatus of claim 12, wherein a number of the plurality of CQIs is M, in which the M is smaller than a number of received beams by the first terminal and is indicated by a higher layer.

14. The apparatus of claim 11, wherein:
before determining whether to use the reception beam group for receiving the uplink signal, the processor further performs steps of:
receiving a sounding reference signal (SRS) from the first terminal; and
measuring the plurality of CQIs by using the SRS.

15. The apparatus of claim 11, wherein:
when receiving the uplink signal by using the reception beam group or a single beam based on a result of the determining, the processor performs a steps of
if a difference between the first CQI and the second CQI is larger than a preset value, receiving the uplink signal by using the single beam, or if the difference is not larger that the preset value, receiving the uplink signal by using the reception beam group.

16. The apparatus of claim 15, wherein the preset value is a value which is indicated by a higher layer.
